(19) United States
(12) Patent Application Publication
(10) Pub. No.: US 2009/0228339 A1
(43) Pub. Date: Sep. 10, 2009

(54) METHOD AND SYSTEM FOR REVENUE PER REVERSE REDIRECT

(76) Inventors: David Wolf, Pepper Pike, OH (US); Scott Fraser, Snellville, GA (US)

Correspondence Address: Fay Sharpe LLP, 1228 Euclid Avenue, 5th Floor, The Halle Building, Cleveland, OH, 44115, US

(21) Appl. No.: 12/398,584

(22) Filed: Mar. 5, 2009

Related U.S. Application Data
(60) Provisional application No. 61/033,965, filed on Mar. 5, 2008.

(51) Int. Cl. G06Q 30/00; G06Q 10/00; G06F 17/30

(52) U.S. Cl. 705/10; 705/26; 705/34; 707/104.1; 707/E17.044

(57) ABSTRACT

A method and system for a reverse online auction process include a dynamic rules-based configuration step. Question-and-answer sets having branches to other questions based on configured rules are generated. Vendor registrations are received from vendors, including vendor product and service information, vendor contact information, and vendor content. A vendor profile is created and stored for each vendor based the product and service information and on answers provided by the vendor to the question and answer sets. Client request leads received from clients are automatically matched to the vendor profile information to determine one or more selected vendors who receive the lead information. However, the received lead information excludes client contact information. Vendors may accept an opportunity to bid for the lead and thereby become candidate vendors. Candidate vendors may submit a bid for the lead, and at least one winning bidder is determined from the candidate vendors.

This application claims benefit of U.S. Provisional Application No. 61/033,965, filed on Mar. 5, 2008, titled METHOD AND SYSTEM FOR REVENUE PER REVERSE REDIRECT.

### FIELD OF THE INVENTION

The present invention relates to the delivery of a comprehensive online customer request for proposal (RFP) and a vendor fulfillment system for the RFP.

### DESCRIPTION OF THE RELATED ART

Potential customers searching for a vendor to fulfill a service request may spend from two to three days, and oftentimes several months, searching for the services company which best meets their needs. During the search process, the potential customer may explain their requirement many times over to different account managers or sales personnel from each company encountered during the search. This inefficient search process wastes valuable time for both the potential customer and the vendor.

On the other hand, businesses that perform services for clients need an effective means for advertising their services to targeted potential clients, particularly in their local area. However, a significant percentage of leads generated by local advertiser's media investments are misdirected, irrelevant and unprofitable for the business/vendor to pursue. Local advertising media, such as, e.g., search engine marketing (SEM), print yellow pages, Internet yellow pages and vendor lead generators do not give specific consumer data that allow advertisers to accurately establish or determine the relevance in value of particular leads. The above-described marketing processes simply push leads to the vendors/advertisers, but fail to adequately discriminate which leads are worth pursuing and which leads are out of scope for the vendor. This creates inefficiencies that consume time, money and resources which businesses can ill afford to waste. That is to say, businesses expend unnecessary time, money and resources addressing and answering out-of-scope service requests and/or unprofitable customer leads. Furthermore, it increases the vendor/advertiser's sales cycles, prolonging the time period required to bring a customer engagement to fruition.

Therefore, vendors are in need of a customer acquisition application that provides contacts more likely to buy, improves the productivity and the cycle time of the sales process, provides the vendor choices on what requirements to receive or reject, costs less than other comparative search methods, provides flexible options with regards to marketing and advertising, focuses on their core competence to eliminate receiving out of scope requirements, provides flexibility with regard to the amount of money spent in order to receive requirements for a customer bid, provides a venue for educating consumers on requirements development, and targets specific locales, project budgets, time frames, and project scopes.

On the other hand, potential customers are in need of a service with the capability to consolidate requirement submittals, improve the productivity and cycle time of the sales process, improve the quality of potential service providers, improve the performance of communications with the potential service providers, enable a thorough description of the service required, have a short learning curve, provide a better chance of securing a reasonable price for services, and educates the potential customer on what to look for in both vendor and requirements development. And, even with all of the above-listed requirements, the potential customers desire a service which is cost-free to use.

### BRIEF DESCRIPTION

A reverse online auction method is provided. Vendor registrations are received from vendors which includes receiving vendor product and service information, and receiving vendor contact information. A client request lead is received from a client in the form of a request for proposal (RFP) or a request for quote (RFQ). The received client request lead includes proposed project information if the client request lead is an RFP, or vendor product information if the client request lead is an RFQ. Selected client request lead information is distributed to selected vendors, but the distributed client request lead information excludes client contact information. One or more of the selected vendors accept an opportunity to bid for the client request lead, and then submit a bid for the client request lead. One or more winning bidders are determined, and the winning bidders are provided the client contact information.

Also provided is an alternative reverse online auction method. In the alternative method, a dynamic rules-based configuration is performed, including generating question-and-answer sets which include branches to other questions based on configured rules. The question-and-answer sets are organized based on industry specific information from each vendor, from a low level of detail to a high level of detail based on information provided by the vendor. Rules are configured for defining a linking order of the question and answer sets. Vendor registrations are received from vendors, wherein the registration process includes receiving vendor product and service information, vendor contact information, and vendor content such as, e.g., advertising material. A vendor profile is created and stored for each vendor based on answers provided by the vendor to the question and answer sets. The profile is also based on the received product and service information of the associated vendor. Client request leads are received from clients, and the leads are automatically matched to the vendor profile information to determine at least one selected vendor. Selected client request lead information is distributed to only the selected vendor(s), however, the selected client request lead information excludes client contact information. Vendors receiving the lead information may accept an opportunity to bid for the client request lead. Vendors accepting the opportunity to bid thereby become candidate vendors. Candidate vendors may submit a bid for the client request lead, and at least one winning bidder is determined from the candidate vendors submitting a bid. Client contact information is then provided to the winning bidder(s).

Further provided is a system for performing a reverse online auction. The system includes a server system having at least a computer system, a network interface for communicating with client systems and/or vendor systems, a user interface, a storage system, and a database server in communication with the server system for performing database retrieval and storage functions. The server system is configured to perform the steps of a reverse online auction as follows. A dynamic rules-based configuration is performed, including generating question-and-answer sets which include branches to other questions based on configured rules. The question-and-answer sets are organized based on industry specific information from each vendor, from a low level of detail to a high level of detail based on information provided by the vendor. Rules are configured for defining a linking order of the question and answer sets. Vendor registrations are received from vendors, wherein the registration process includes receiving vendor product and service information, vendor contact information, and vendor content such as, e.g., advertising material. A vendor profile is created and stored for each vendor based on answers provided by the vendor to the question and answer sets. The profile is also based on the received product and service information of the associated vendor. Client request leads are received from clients, and the leads are automatically matched to the vendor profile information to determine at least one selected vendor. Selected client request lead information is distributed to only the selected vendor(s), however, the selected client request lead information excludes client contact information. Vendors receiving the lead information may accept an opportunity to bid for the client request lead. Vendors accepting the opportunity to bid thereby become candidate vendors. Candidate vendors may submit a bid for the client request lead, and at least one winning bidder is determined from the candidate vendors submitting a bid. Client contact information is then provided to the winning bidder(s).

### BRIEF DESCRIPTION OF THE DRAWINGS

FIG. 1 is a block diagram showing summary of an RPRR system process according to concepts of the present application;

FIG. 2 is a block diagram describing vendor registration and vendor matching procedures;

FIG. 3 is a block diagram describing RFP distribution and vendor acceptance/rejection;

FIG. 4 is a block diagram describing lead purchase generation in a bid engine;

FIG. 5 is a flow chart of an embodiment of an RPRR system according to concepts of the present application;

FIG. 6 is a block diagram of an exemplary RPRR system incorporating concepts of the present application;

FIG. 7 is an exemplary rules-based vendor/client questionnaire form;

FIG. 8 is a first exemplary rules-based configuration screen;

FIG. 9 is an exemplary Book of Forms Decisioning Page configuration screen;

FIG. 10 is an exemplary Book of Forms Decisioning Steps configuration screen;

FIG. 11 is an exemplary Decisioning Step Edit screen;

FIG. 12 is an exemplary Decisioning Controls screen;

FIG. 13 is an exemplary Category search configuration screen;

FIG. 14 is an exemplary Category Details screen;

FIG. 15 is an exemplary User Registration screen;

FIG. 16 is an exemplary Plumbers configuration screen;

FIG. 17 is an exemplary Profile Data screen;

FIG. 18 is an exemplary RFQ data form;

FIG. 19 is an exemplary Directory Print Advertisement configuration screen;

FIG. 20 is an exemplary Video Search screen;

FIG. 21 is an exemplary alternate member profile screen; and

FIG. 22 is an exemplary alternate vendor profile screen.

### DESCRIPTION OF THE PREFERRED EMBODIMENTS

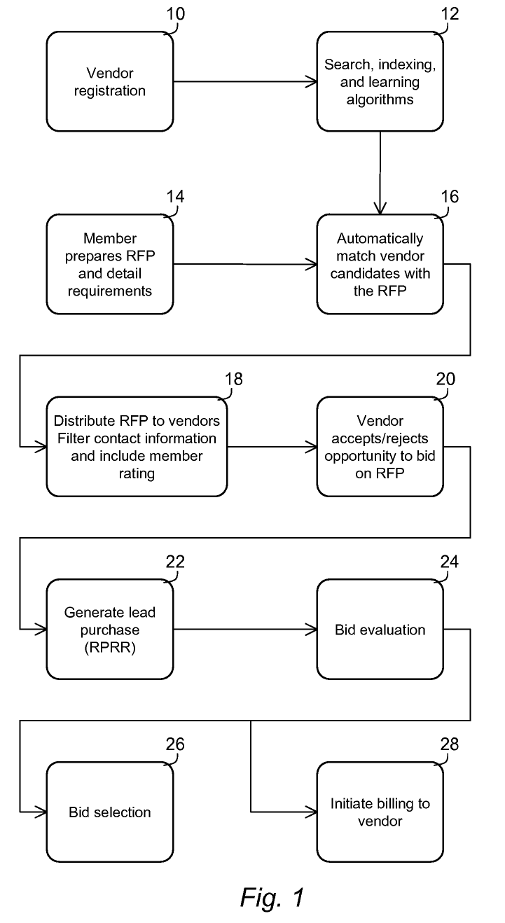

Described herein is a reverse online auction process referred to hereinafter as Revenue per Reverse Redirect (RPRR). RPRR is a reverse online auction process that enables consumers to specify a very specific set of requirements, parameters and guidelines for a service they require from a vendor and then provides vendors/advertisers the ability to select which of the consumers they are interested in bidding on in order to receive further information related to the consumer's request. In this manner, the vendor receives only the customer requirements and guidelines that they have successfully bid on and paid for through a reverse auction model described hereinafter in more detail. With reference to FIG. 1, a summary flow chart is shown which provides a brief overview of the RPRR process. At step 10, vendors register with an RPRR system for providing information about products and services which fall within the scope of offerings from the vendor. At step 12, search, indexing, and learning algorithms process information provided by the vendor at registration, and the vendor registration data is stored for further use.

Independently of the vendor registration step 10, at step 14, members prepare a request for proposal (RFP) and provide detail requirements related to the RFP. The system described herein operates with equal efficacy with respect to requests for quotes (RFQs), however, the description herein will refer only to RFPs for the sake of convenience. Based on the prepared RFP, at step 16, the RPRR system automatically matches vendor candidates with the RFP. At step 18, the member chooses to submit the completed RFP, and the completed RFP is distributed to vendors who successfully match the requirements set forth by the member. In one embodiment, the submit button activates an internal email engine and/or SMS communication to the vendor. This ensures the privacy of the consumer and protects the identity from the vendor until the vendor accepts the lead. This process initiates a notification to the appropriate vendor contact points as defined in the initial query. A member rating may be included with the distributed RFP, based on previous activity of the member and feedback from vendors who have previously dealt with the member. However, as mentioned, contact information identifying the particular member is filtered from the RFP in order to prevent the vendor from contacting the member for negotiations independently outside of the RPRR system. Although the present embodiment is described using email as a vendor notification method, it is to be appreciated that other means of notification of vendors fall within the scope of the present application.

The vendor may be given a limited time to respond to the RFP query, e.g., 24 hours. In some embodiments only a limited number of vendors may be given the customer contact information, e.g., only the first five vendors to reply to the query are given the customer contact information. All others are notified that it is too late to respond, or that their response was provided too late, and therefore, they may not download the lead.

The potential customer or member can be provided the ability to expand the bid list, and based on this, the vendors that were previously denied the opportunity to download the lead because of the lateness of their response can then be included. Each vendor is given the option to view all information completed by the user as it pertains to the RFP. The only information the vendor cannot see is the user name and contact information. Based on the provided information, the vendor can decide whether or not to purchase the lead. If the vendor chooses to purchase the lead, the vendor replies to the notification email which then enables the vendor to download the relevant customer information in order to contact the potential customer.

In preferred embodiments, vendors are given the opportunity to bid for key positions in the member search. A bidding engine enables vendors to bid for a position in, e.g., the top five of the search results and ultimately have a better chance for winning the lead. A small variable fee such as $0.30 to $5.00 may be charged for the opportunity to bid for key positions. During the process of completing their profile, vendors may set bid prices for the various types of leads they wish to bid on. These bids can range from static amounts for simple customer acquisition to range bids for thresholds of estimated customer budgets or preset job estimates based on what the job might cost. The preset job estimates can be predefined internally in the formation of an industry and job specific family.

The bidding engine preferably captures information regarding returned searches including, e.g.:
How many times the vendor is returned in a search;
How much the vendor paid per result in $0.05 increments;
The vendor's daily tally of bid costs;
How many searches the vendor did not show in, due to others outbidding them;
Their average position in the search;
Their number of actual positions in a search result (e.g., #1—10 times, #2—3 times, etc.);
Times of day searches occurred for their specific category by hour or minutes;
Other categories that were a near match and the associated statistics; and
Emailing and/or SMS capability to let Vendors know when they were outbid and by an average of how much.

A daily reminder may be made available so vendors can utilize the Vendor Interface to change their bid information. Additionally, if a Vendor is not listed in a search result and key position due to an unusually high number of vendors and/or a higher bid cost, the vendor may be listed under a heading that will display, e.g., “Other Vendors Who Can Fulfill Your Requirement”.

After the query is complete, the user receives the results of the query on their screen. The screen displays the potential vendors capable and interested (based on keyword information provided earlier) in providing the service required by the user, and, at step 20, each vendor to whom the RFP was distributed accepts or rejects the opportunity to bid on the RFP subject to the above-described limitations. Upon acceptance of the opportunity to bid on the RFP, a lead purchase is generated at step 22. As soon as the vendor clicks on, e.g., “Accept Lead”, billing is initiated through the lead purchase. This process is a culmination of the RFP distribution step 18 and the vendor acceptance step 20. As previously described, the first five vendors to accept the lead are billed. The amount billed is equal to an amount necessary to place in the top five bidders, but can also be the lowest bid necessary to place in the top five. In other words, if a vendor set their bid range between $1.00 and $2.00 and the bid amount required to win the lead was only $1.75, this is the highest amount that will be billed. The system determines bid ranking based on the range of bids per vendor and sorts these in order to determine the amounts in order to round out the top five bidders. This portion is included in a negotiation workflow described in further detail below.

At step 24, a bid evaluation engine processes and analysis each of the accepted vendor bids. As a result of the bid evaluation, a bid selection process 26 selects one or more winning vendor bids. The winning vendors are then provided with appropriate contact information for negotiations with the RFP-submitting member. Further, at step 28, billing is initiated to the winning bidders. At the time the vendor replies to the previously described notification email, the amount of their bid, finalized by the bidding engine, is charged to the vendor. Collection of this revenue is accomplished essentially immediately via credit card or through a monthly direct billing function. The monthly direct billing function may be a separate system designed to interact with the email notification system and preferably provides a safety mechanism such as, e.g., asking the vendor for permission to proceed with the billing. The billing function notifies the vendor of the cost of the lead which is determined by the estimated budget of the project submitted by the member/user, or by a flat rate (based on the category type) if no budget is mentioned or indicated. At this point a report is generated that details which vendors replied to the member requirement and the amount of money invoiced. This ensures that revenue splitting, should there be a partner involved, is accurate.

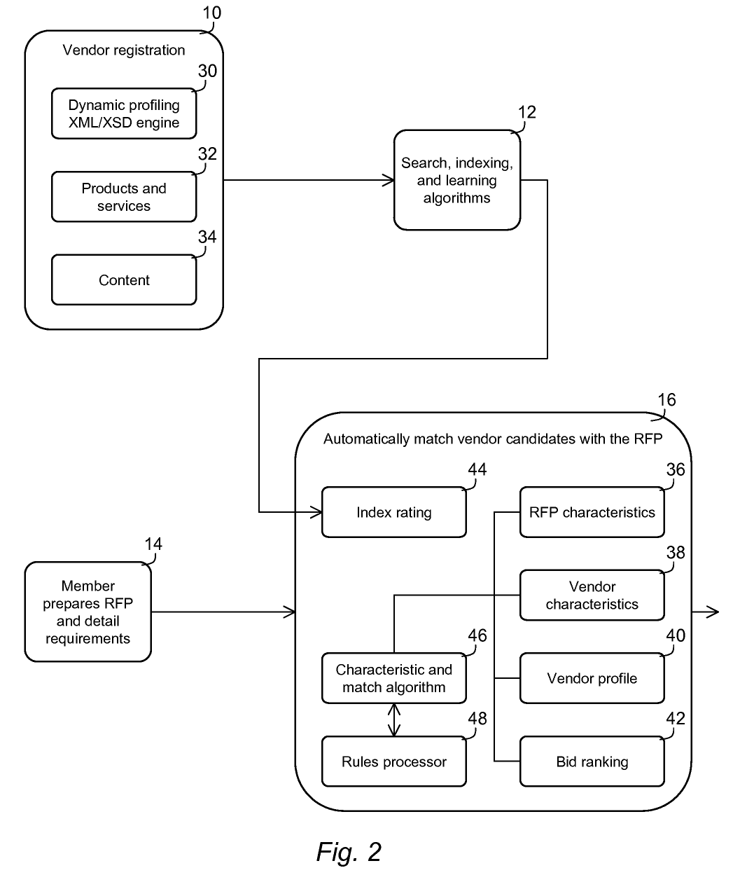

With reference now to FIG. 2, and continuing reference to FIG. 1, the vendor registration step 10 and the vendor matching step 16 are described in more detail. Included in the vendor registration step 10 are a dynamic profiling XML/XSD step 30, products and services information acquisition step 32, and content acquisition step 34. The XML/XSD step 30, utilizing an XML/XSD engine, enables XML and XSD forms generation for the RFP submissions. This enables different formats to be defined easily and associated at the data and ontology level with vendor profiling which is also implemented using the same XML and XSD model. Base level information is thus unified for evaluation within the vendor matching step 16. This further enables rules space profiling to define a set of decision trees for the vendors. Vendors are classified and organized based on the kinds of skills, trades and expertise being offered. The vendor answers a series of guided questions, and further questions are provided to the vendor specific to their industry and the focus of their service. Essentially, it is a decision tree that evaluates entries of information being entered and determines what information to next obtain from the vendor. This leads to a full population of the vendor's products and services within their profile.

There are two aspects to vendor profiling. First, there is a defined administration set of tools which enable general profiling around the vendors with respect to, e.g., which types of questions and decision trees are going to be applied to the vendors. Secondly, there is a run-time component which the vendors interact with when they register through that run-time component, further narrowing the type of information and providing information needed based on service, products and the profiling being gathered up during the process. For instance, the profiling may include gathering hours of operation, required lead time to provide a service, e.g., two weeks because of workload. This gathered information can further be used in the search for candidate vendors with respect to a member RFP. Additional examples of profile data include specified conditions such as, e.g., no acceptance of jobs less than $500, no service on certain days, etc. The profiling process digs deeply into what a vendor will or will not provide in their scope of services. In addition to profiling a vendor with regard to information on the scope of services of the vendor, information is also gathered, e.g., on the maximum amount a vendor is willing to bid based on thresholds that members enter based on their budgets such as, e.g., $500 on a plumbing job. A vendor may then be willing to bid between $0.20 and $1.50 to obtain the lead for a job in that range. In one embodiment, vendors having the five highest bids are provided with the opportunity to bid on the project.

Essentially, there are service level types of criteria about the vendors in terms of their availability and types of service that they perform, and there are demographic types of profiles about them in terms of what types of business they will perform and what types of business they will accept in terms of dollar values and timing range. For example, with regard to dentists, relevant criteria might include what types of fillings they use such as, e.g., metal fillings, porcelain fillings, gold caps, etc. The information gathered describes very detailed types of services. The profiling is a drill-down model to information that is relevant. Thus, based on the path the vendor is following, very little information, if any, is required in areas being bypassed by the path, and more detail is required related the path that they are on. The granularity is determined based on the path. This further aids the matching and service analysis. However, even though the vendor may provide fine granularity in certain areas, the vendor is still given the option to request all customer bids, or at least all bids that fall generally within their area of expertise.

The learning algorithms of the search and indexing step 12 essentially accumulate historical data and apply pattern analysis on the recorded history. This learning process establishes ratings on different kinds of decisions that occurred during the profiling, i.e., actions and outcomes. Thus, the system is self-refining so that as more and more information is accumulated by the vendor profiling and the corresponding results, it is tied back to successful RFPs. A second series of rating factors is provided, and these are updated continuously. The learning algorithm evaluates historical results, and it weights history by assigning weighting factors based on different rules and criteria. On subsequent matching analysis, the weighting factors are applied on the assessment and, whether matching on a vendor or distributing an RFP for doing bid evaluations, learning results are used to further optimize the assessment.

The matching step 16 which automatically matches vendor candidates with member RFPs includes RFP characteristic analysis 36, vendor characteristic analysis 38, vendor profile analysis 40, and a bid ranking process 42. Also included in the vendor matching step 16 are index rating factors 44 which incorporate the above-described ratings. A characteristic and match algorithm 46, in cooperation with a rules processor 48, performs the vendor candidate matching based on the RFP characteristics 38, vendor profile 40, bid ranking 42 and index rating factors 44.

From the member side of the matching process, when the member goes online to perform the RFP preparation step 14, the member also goes through a series of decision trees and fills out information as specific as the member desires. For example, a member searching for a dentist for child may want to know what kind of a sedative the dentist uses, e.g., laughing gas; and if the dentist “knocks you out” or just uses Novocain, etc. The matching process may seek further details right down to questions such as: “Is the doctor kid friendly?”; “How many doctors are on the staff?”; “How many hygienists are on the staff?”; “How many work stations are available?”; “What is a typical wait time?”; “What kinds of insurance are accepted?” and so forth. While this information is provided by the member, it is optional and the member has the option of being very general in nature or very specific.

Once the member has provided the requisite and optional information, the system utilizes the collected information in performing the automatic vendor matching step 16 as previously described. Once a member initiates a search, e.g., “hits submit”, a matching algorithm finds matching vendors and provides a percentage match of a member's requirements to the vendors capabilities. Based on these results, the RPRR system returns, e.g., the top five vendors, ranked based on their bid and percentage match. In some embodiments, an algorithm weights the percentage match and the bid amount against each other. The rules processor 48 enforces the ranking this and may rank all of the vendors, however, only the top 5 vendors, or more generally, N vendors, are presented. If the member does not accept any of the first N vendors, the member is presented the opportunity to select the next N vendors for viewing and consideration.

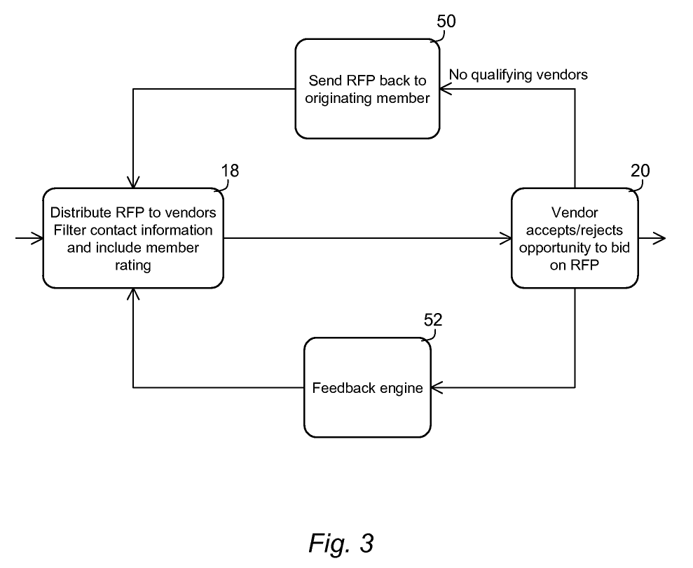

With reference now to FIG. 3, and continuing reference to FIG. 1, additional detail is provided with respect to the RFP distribution step 18 and the vendor acceptance/rejection step 20. As previously described, when a member submits an RFP, the member is provided with a list of the top N candidate vendors. For example, there may be a list of vendors with a check box beside each vendor's name, and a link to the vendors advertising print or video commercial may also be provided. Vendors have the option of providing audio-visual files pertaining specifically to the members search. The vendor may, e.g., have five different commercials geared to five different types of service. For example, a kid-friendly dentist commercial, a general dentistry video, etc. That is to say, the advertising is directed specifically to the type of search the member submitted. The vendor preferably submits these video files when registering, as part of the content 34 shown in FIG. 2. The audio-visual files are preferably displayed in a separate or new window so the member doesn't lose their place on the site when viewing an advertisement or audio-visual file.

In rare instances, particularly when a member performs a search with a very detailed RFP, it is possible that no qualifying vendors will be found by the matching step 16. In such cases, an RFP return step 50 is provided for returning the RFP back to the originating member. Also provided is a feedback engine 52 providing vendors the opportunity to provide feedback and ratings on members in a manner similar to that used in popular online auction sites. Follow-up communications to the vendor/customer are made via email, or customer service personal inquiry, to ensure that the system is working properly and that the customer is satisfied by the response. Additionally, the customer may be asked about feature enhancements they would like to see in order to enhance the product in future versions.

Once the service has been provided, both the vendor and the user are provided an eBay type of feedback system that enables each to rate the other. These ratings are made available in future searches for the user, and to the vendors as the leads are sent to them. It is to be appreciated that, although the RFP return step 50 and the feedback engine 52 are shown as being connected between the vendor acceptance/rejection step 20 and the RFP distribution step 18, these particular steps may be incorporated elsewhere in the RPRR system.

Further, as part of the vendor acceptance step 20, when a vendor accepts the opportunity to bid on a particular RFP, to make the bidding process more meaningful to the vendor, additional data can now be provided to the vendor. This enables the vendor to bid higher for particular leads such as, e.g., roofing leads in affluent neighborhoods. The first presentation of the RFP to the vendor before acceptance by the vendor may include, e.g., geographic location. Upon acceptance on the opportunity to bid, the vendor may then be provided with additional information such as, e.g., size and square footage of the house or building. Of course, as previously discussed, prior to accepting the opportunity to bid on an RFP, consumer or member contact information is withheld from the vendor. And, vice versa from the member standpoint, members are allowed to see which vendors are available and are allowed to prescreen the vendors but are prevented from obtaining contact information that would allow them to transact for a business relationship for goods or services or a product outside of the RPRR system.

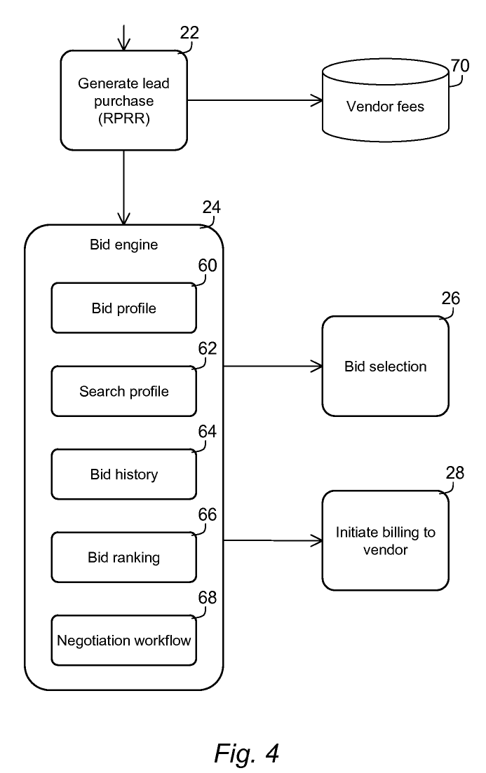

With reference now to FIG. 4, and continuing reference to FIG. 1, additional detail is provided with respect to the lead purchase generation step 22 in the bid engine 24. Upon vendor acceptance of the opportunity to bid for an RFP, a lead purchase is generated at step 22 and a record of the charges is stored in a vendor fees database 70. The bid engine 24 includes bid profiling module 60, search profiling module 62, bid history maintenance module 64, bid ranking module 66, and negotiation work flow module 68. It is to be appreciated that the bid engine 24 and the bid selection process 26 operate in a manner similar to that known by those of skill in the art.

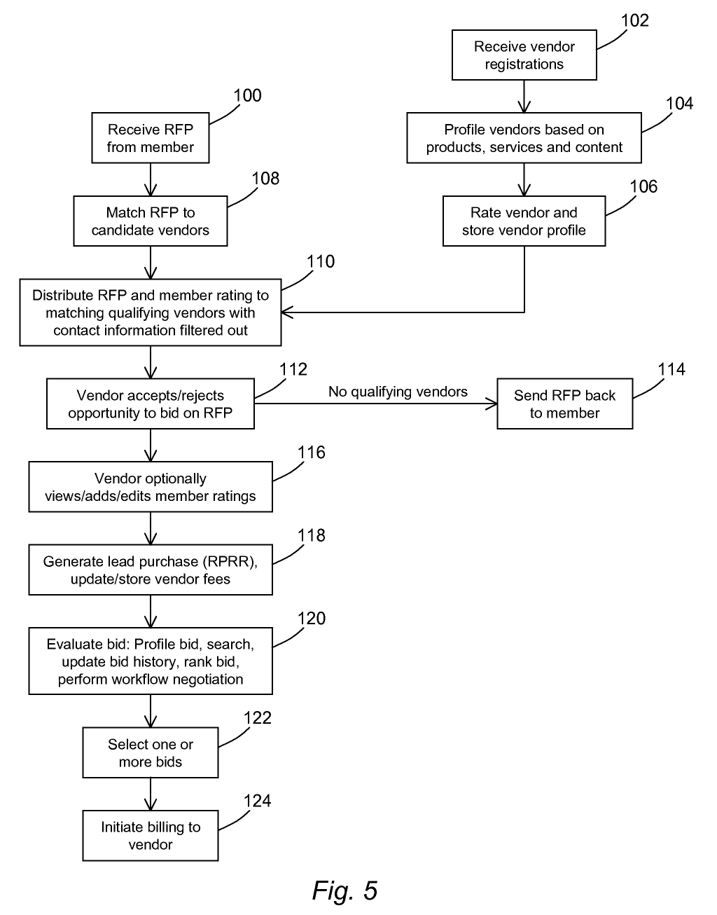

With reference now to FIG. 5, a flow chart is shown for an implementation of the previously described RPRR system. At step 100, an RFP is received from a member as previously described. In parallel, or independently, vendor registrations are received at step 102. The vendors are profiled at step 104 based on information provided by the vendors relating to products, services and content describing services offered by the individual vendors. At step 106, each vendor is rated and the vendor profile for each vendor is stored. Each of the vendor registration steps 102-106 operate as previously described regarding vendor registration and profiling steps 10-12. When an RFP is received from a member at step 100, at step 108 the RFP is matched to candidate vendors based on stored vendor profile information previously stored at step 106.

At step 110, the RFP is distributed, preferably including a member rating, to matching qualifying vendors selected by the member, but with member contact information filtered out of the RFP. At step 112, candidate vendors have been notified of the RFP and offered an opportunity to accept or reject permission to bid on the RFP. In the event that no qualifying vendors accept the opportunity to bid on the RFP, or if there are no qualifying vendors, the RFP is returned to the member at step 114. At step 116, vendors accepting the opportunity to bid on the RFP are offered the opportunity to provide member rating feedback. At step 118, for vendors who have accepted an opportunity to bid on the lead, a lead purchase is generated and a vendor fees database is updated with the generated lead purchase information.

At step 120, the bid is evaluated by performing the previously described steps of profiling, searching, updating bid history, ranking the bid and performing work flow negotiation. As a result of the bid evaluation, one or more bids are selected at step 122 as winning bids, and the corresponding vendors are provided with lead contact information to enable the vendors to bid on the member RFP. Further, at step 124, each winning bid causes a billing to be initiated for the associated vendor. It is to be appreciated that various billing methodologies fall within the scope of the present application. For example, each of the winning vendors, in the event that there is more than one, may be billed either according to the amount that they bid, or may be billed according to the lowest winning bid amount.

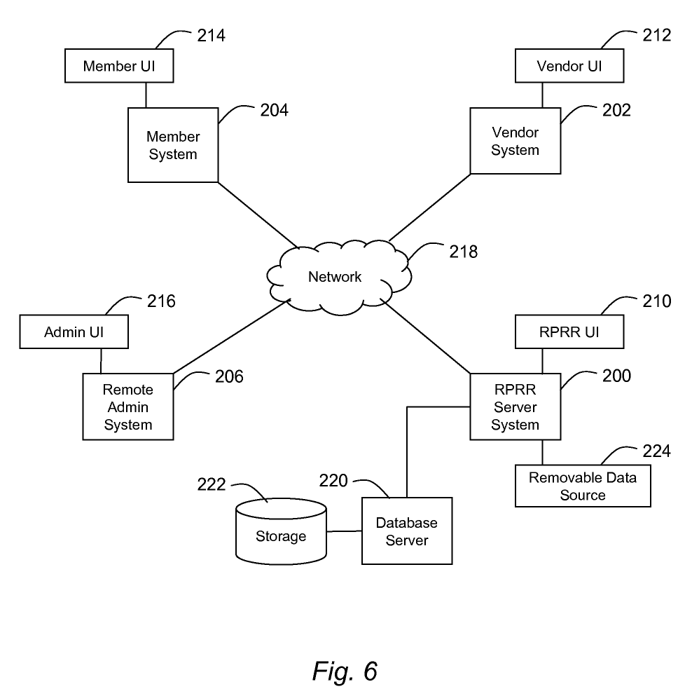

With reference now to FIG. 6, a block diagram is shown for an exemplary RPRR system incorporating concepts of the present application. The system shown includes an RPRR server system 200, a vendor system 202, a member system 204, and preferably includes a remote administration system 206. It is to be appreciated that each of the systems 200-206 are computer systems as well known by those skilled in the art including, e.g., at least one CPU, random access memory, storage systems, and network interfaces. For this reason, the systems are not described in further detail except to note that the RPRR server system 200 is configured to perform methods of the present application as previously described with reference to FIGS. 1 and 5. Each of the systems 200-206 preferably includes a respective user interface 210-216. Each user interface, as also well known in the art, may include a display device, an input device, and a pointing device. Each of the systems 200-206 is able to communicate with the remaining systems by means of a network 218 such as, e.g., the Internet. It is to be understood that the vendor system 202 is a system utilized by each vendor to perform vendor tasks such as vendor registration, bid acceptance/rejection, member lead negotiation, and member feedback as previously described. It is to be further appreciated that although only one vendor system is shown in the figure that, in typical situations, each vendor typically would utilize their own vendor system embodiment. Similarly with the member system 204, the member system is a computer system utilized by an individual member for purposes of providing an RFP and negotiating with vendors.

The RPRR server system 200 may incorporate remote administration capabilities which can be utilized by an administrator operating the remote administration system 206. The RPRR server system 200 preferably includes a database server 220 and a storage system 222 for storing databases utilized by the server system. Information stored by the database server 220 on the storage system 222 includes vendor registration details as previously described, and member RFPs as previously described. Further stored on the storage system 22 are the index rating factors 44, the RFP characteristics 36, vendor characteristics 38, vendor profiles 40, and bid rankings 42 as previously described with reference to FIG. 2. Further still, member feedback information may be stored on the storage system 222. Further yet, information stored on the storage system 222 includes bid profiles, search profiles, bid history, bid ranking, negotiation workflow, and vendor fees. A removable data source 224 is provided for exchange of data with other computer systems disk systems, the removable data source including devices such as hard drives, optical drives, memory sticks and other volatile and non-volatile storage media systems. The removable data source may be used, e.g., for inputting programs enabling the RPRR server system 220 to perform procedures according to the concepts as described herein.

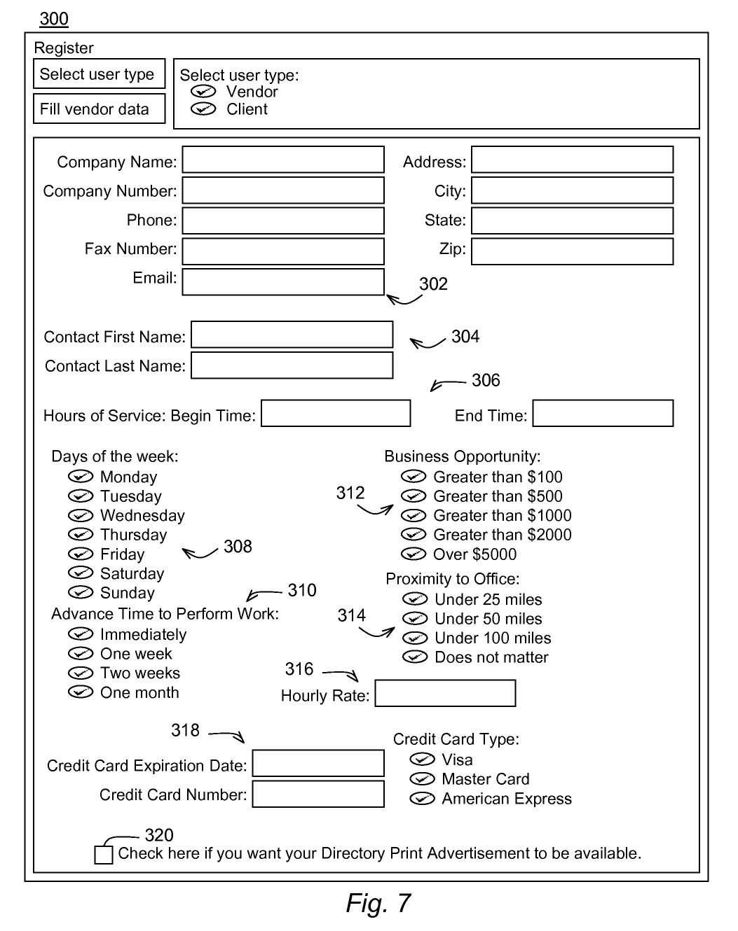

With reference now to FIG. 7, and continuing reference to FIGS. 1-2, an exemplary rules-based vendor/client questionnaire form 300 is shown. The vendor/client registration form 300 is used to collect information common to all vendors and clients. Included, e.g., are company information fields 302 and contact identities 304. Additional information which is commonly relevant to clients and vendors are hours of service 306, available days of the week 308, advance time required to perform work 310, business opportunity 312, i.e., what range of jobs are acceptable, and proximity to office 314, i.e., maximum service radius of vendor. An hourly rate field 316 is provided for entry of optional or required hourly job rates, and credit card information fields 318 are provided for vendor and client billing purposes. Finally, a Directory Print, newspaper or magazine Advertisement option 320 is provided to make available the Directory Print, newspaper or magazine Advertisement. It is to be appreciated that the vendor/client questionnaire form 300 is only exemplary for the purpose of illustrating a first level of information that is acquired from clients and vendors during registration. Additional exemplary forms are described hereinafter to illustrate how the RPRR system “drills down” to acquire additional information particularly relevant to the client or vendor.

The dynamic profiling XML/XSD step 30 implements a dynamic vendor profiling wizard as a dynamic and rules-based configurator to enable the establishment of different question-and-answer sets with branching to other questions based on configured rules. The profile configurator and rule evaluation engine are implemented in a form that is generic in nature and is referred to hereinafter as the Book of Forms. It is implemented and presented such that a marketing person, who upon gathering the industry specific information from the vendor, can build menu-driven categories that dive deeper into detailed information as more specific information is provided by the vendor. An example of the menu-driven categories might be as shown in Table 1 below.

TABLE 1

| | |
|---|---|
| i. | Doctor |

| | |
|---|---|
| 1. | Internal Medicine |

| | |
|---|---|
| a. | Lungs |

| | |
|---|---|
| i. | Surgeon |

| | |
|---|---|
| 1. | Places of Business |

| | |
|---|---|
| a. | Office |
| b. | Hospital |
| c. | Hospice |

| | |
|---|---|
| ii. | Internist |
| iii. | Therapist |
| iv. | Specialist |

| | |
|---|---|
| b. | Liver |
| c. | Kidneys |
| d. | Pancreas |

| | |
|---|---|
| 2. | Pediatrics |

| | |
|---|---|
| a. | Infant |
| b. | Toddler |
| c. | Child |
| d. | Teenager |

| | |
|---|---|
| i. | Boy |
| ii. | Girl |

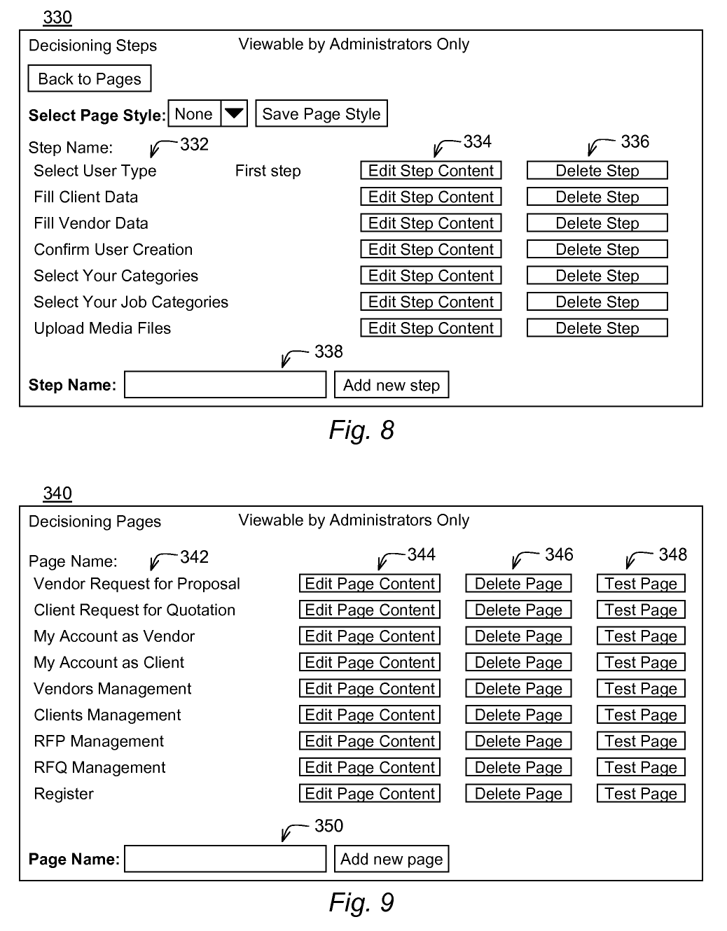

With reference now to FIG. 8, a first exemplary rules-based configuration screen 330 of the vendor profiling wizard is shown. It is to be appreciated that the configuration screens such as the first exemplary rules-based configuration screen are for purposes of configuring the RPRR system. They are viewable only by administrators of the system, and are not viewable by either client members or vendors. The first exemplary rules-based configuration screen includes one or more step names 332 which can be edited or deleted by selection of an Edit Step button 334 or a Delete button 336. New steps may also be added by input of a new step name and selection of an “Add New Step button in a new step input area 338.

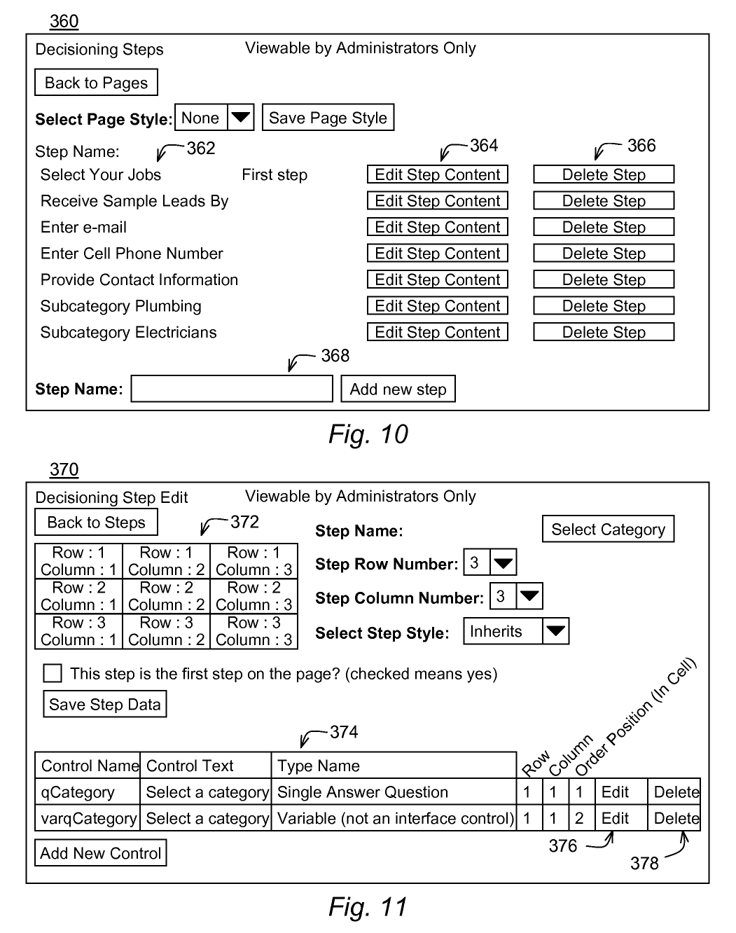

It is not necessary or required that the Book of Forms be configured and populated by the developer. The Book of Forms is built in such a way that an authorized user or administrator can build out a directory structure to populate fields for different industry sectors and specialties. With reference now to FIG. 9, an exemplary Book of Forms Decisioning Page configuration screen 340 is shown. The Book of Forms Decisioning Page configuration screen 340 shows one or more RPRR system page names 342, each of which may be selected for editing by Edit Page buttons 344, deleted by selection of a Delete Page button 346, or tested by selection of a Test Page button 348. A new page may be added by entry of appropriate page information in the New Page area 350. The fields shown provide essentially unlimited depth and capacity to facilitate deep-dive searches to multiple levels of customer specificity. The page information fields can be defined as required, enabling any number of questions, fields, and answer sets. Rules can be configured and applied for selecting answer sets and default values. Rules can be configured and applied for defining the flow of the form. For example, with reference to FIG. 10, an exemplary Book of Forms Decisioning Steps configuration screen 360 for configuring page steps is shown. The page being configured is selected in the first Book of Forms Decisioning Page configuration screen 340. The Book of Forms Decisioning Steps configuration screen 360 shows one or more decisioning steps 362 of the page, each of which may be selected for editing by Edit Step buttons 364 or deleted by selection of a Delete Step button 366. A new step may be added by entry of appropriate page information in the New Step area 368.

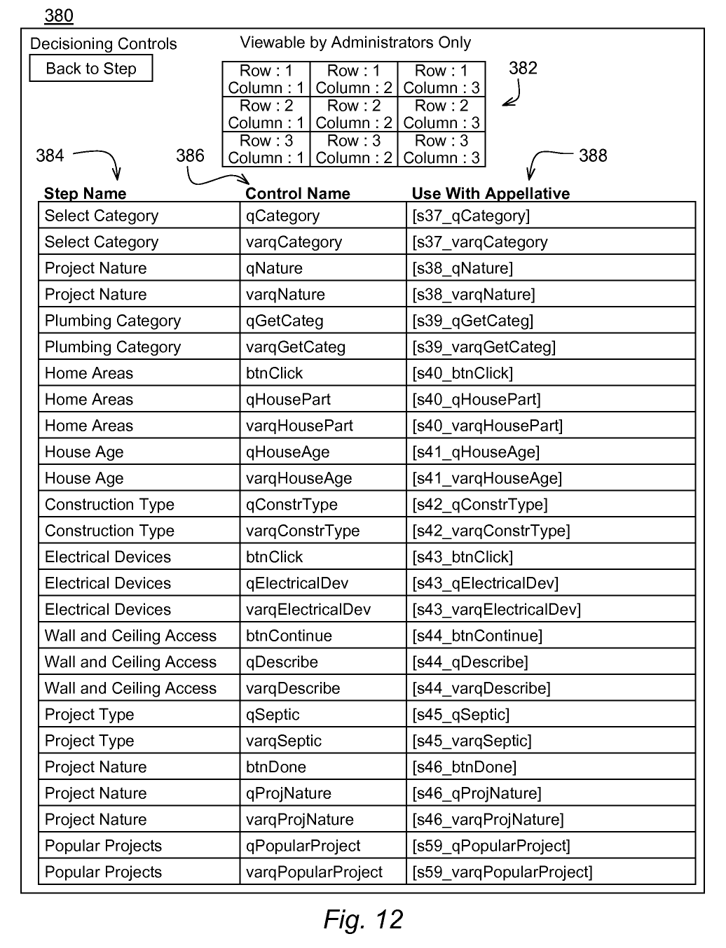

Drilling down further into the configuring process by selection of an Edit Step button 364 shows more detailed information for the selected step. For example, with reference to FIG. 11, an exemplary Decisioning Step Edit screen 370 is shown. A control matrix 372 is provided, and each named control 374 may be selected by one of the Edit Control buttons 376, or deleted by selection of a Delete Control button 378. Selection of an Edit Control button 376 provides access to the lowest level of management, i.e., Decisioning Controls, according to one embodiment of the present application. With reference to FIG. 12, an exemplary Decisioning Controls screen 380 is shown. A matrix cell selection area 382 is provided as are columns for associated Step Names 384 and Control Names 386, and also related Appellatives 388 for use with the named step and control.

In the preferred embodiment, search engine plug-ins are implemented in the RPRR application platform, and these enable integration with internet directory partners using the OpenSearch specification. OpenSearch is a collection of technologies for publishing of search results in a format suitable for syndication and aggregation. Websites and search engines are thereby able to publish search results in a standard and accessible format. The specification enables custom attributes and taxonomy tables to be added to the search engine and Internet directory partners' databases and accommodate the information required to interface with the vendor.

The RPRR system preferably includes a crawler, which operates at scheduled intervals, and which traverses the site and vendor content and extracts the content into a unified format. The system further preferably includes a content indexer which interacts with the crawler. The indexer applies an A-Z indexing model and establishes keyword metadata references. The keyword metadata references are weighted with a ranking factor based on the incidences found and the relevance of related keyword metadata. The established keyword metadata is applied as part of the previously described matching evaluation criteria when evaluating an RFP with a vendor.

The previously described learning algorithm preferably uses a naive Bayes classifier methodology. The naive Bayes classifier is a simple probabilistic classifier based on applying Bayes' theorem with strong (naive) independence assumptions. An advantage of the naive Bayes classifier is that it requires a small amount of training data to estimate the parameters (means and variances of the variables) necessary for classification. This learning algorithm is very useful in content correlation and applying weighted learning to categorization taxonomies. The learning algorithm accesses the keyword metadata and applies defined training scenarios to rank and organize information within categories and apply to the matching engine. All categories are defined and configured in the RPRR application. The application includes a configuration module for defining the evaluation criteria and algorithms for proximity, opportunity, hours, and other factors to include in the scoring evaluation.

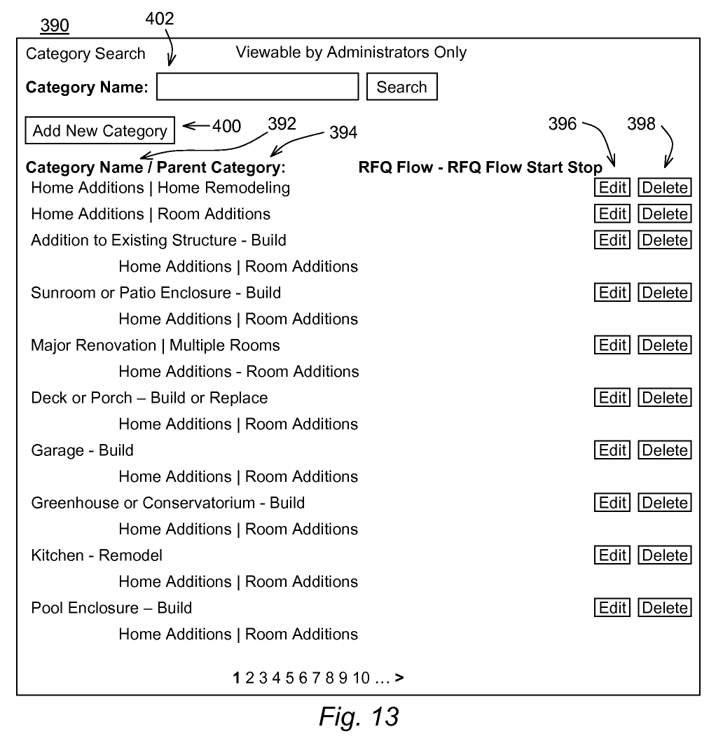

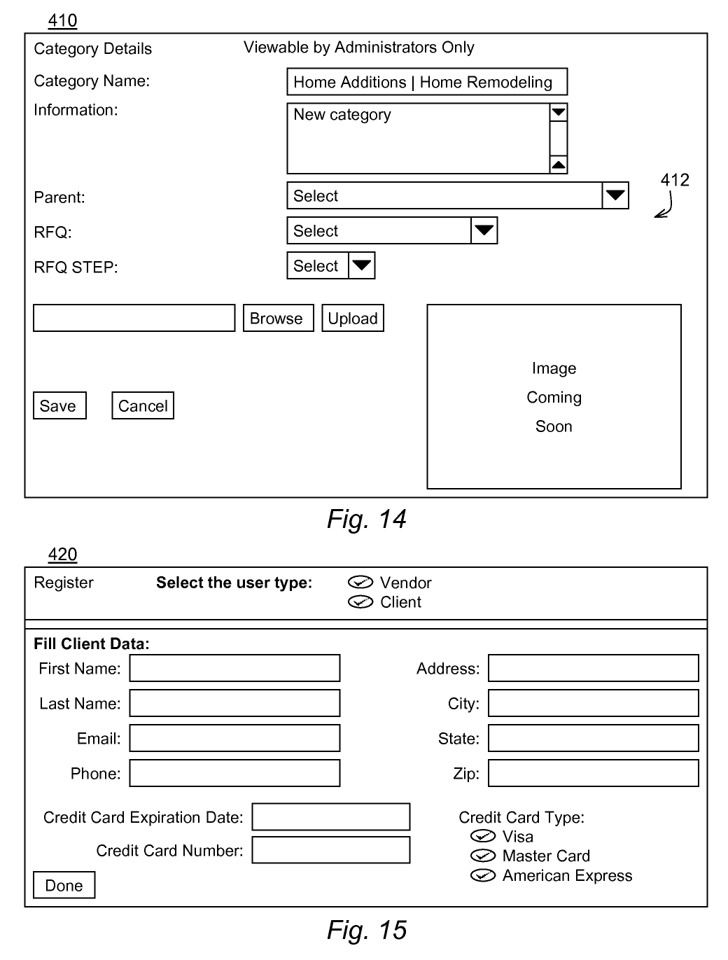

The RPRR system preferably has the capability to designate “Key Categories and Sub-Categories”. The categories are applied during learning processing. The categories are able to relate directly to a vendor name and also relate to the billing program in order to be able to bill a vendor for each category they wish to be associated with. With reference now to FIG. 13, a Category search configuration screen 390 is shown. The screen preferably includes a list of Category Names 392 and associated Parent Category 394, if any. Also provided are Category Edit buttons 396, Category Delete buttons 398, and provision for adding new categories 400. A category search facility 402 is provided in preferred embodiments. Selecting or clicking on a Category Edit button 396 enables management of the selected category by means of a Category Details screen 410 as shown with reference now to FIG. 14. The Category Details screen 410 includes category editing controls and input fields 412 for entering detailed information and relationships related to the selected category.

It is to be appreciated that the “Book of Forms” described herein will not contain any user or vendor-specific information. It will simply contain specific fields of information and subsequent searchable categories. For all intents and purposes, queries by users will go through the “Book of Forms” to get to the appropriate vendors who match what the users are looking for.

With regard to RFP preparation as described previously with reference to the RFP preparation step 14, if a user decides to move forward with a potential requirement, the user registers with the site, providing all pertinent contact information. The user also completes a web-based wizard requirements form or uploads an already prepared RFP or RFQ. A repository of RFP/RFQ examples are preferably made available to users for their convenience. The user registration process gathers typical information about the user. Table 2 shows exemplary information that can be gathered.

TABLE 2

| | |
|---|---|
| a. | Name |
| b. | Address |
| c. | City |
| d. | State |
| e. | Country |
| f. | Zip Code |
| g. | Home Phone |
| h. | Cell Phone |
| i. | Office Phone |
| j. | Email |
| k. | Alternate Email |
| l. | Best Time of Day to Reach |

| | |
|---|---|
| i. | Morning |
| ii. | Afternoon |
| iii. | Evening |

| | |
|---|---|
| m. | User Name and Password |
| n. | Interests (Optional Selection from Generic Categories) |
| o. | Opt Out Function for Special Vendor Offers |
| p. | Privacy Disclaimer Recognition |

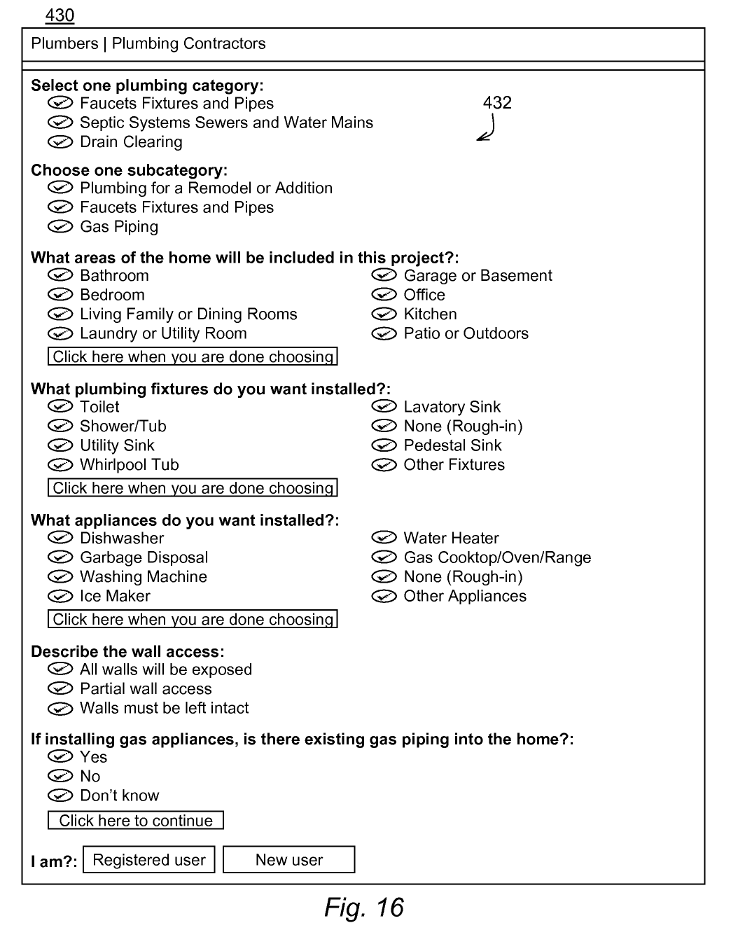

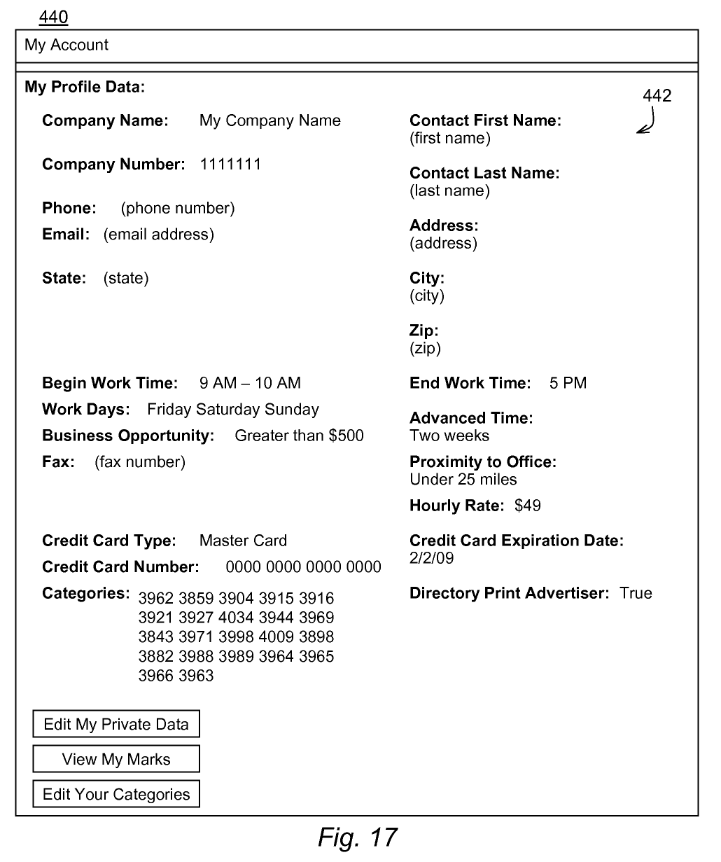

With reference to FIG. 15, a suitable User Registration screen 420 is shown. It is to be appreciated that the user may be guided through a series of rules-based screens during the registration process. The previously described profiling wizard walks the user through the gathering of required information as defined by the “Book of Forms”. Each category may be built differently and the RPRR application preferably able to pick the correct category based on the users input such as, e.g., “Plumber”. For example, with reference now to FIG. 16, a Plumbers configuration screen 430 for the category of “Plumbers|Plumbing Contractors” is shown. A series of category-related questions 432 are presented to the user for guiding the user's configuration process. Also provided by the RPRR system is the ability for a user to enter and/or view their profile data. With reference to FIG. 17, an exemplary Profile Data screen 440 is shown which preferably includes private data 442 relating to the user. As previously described, the private data 442 is not shown to other members or vendors during the RPRR bidding process.

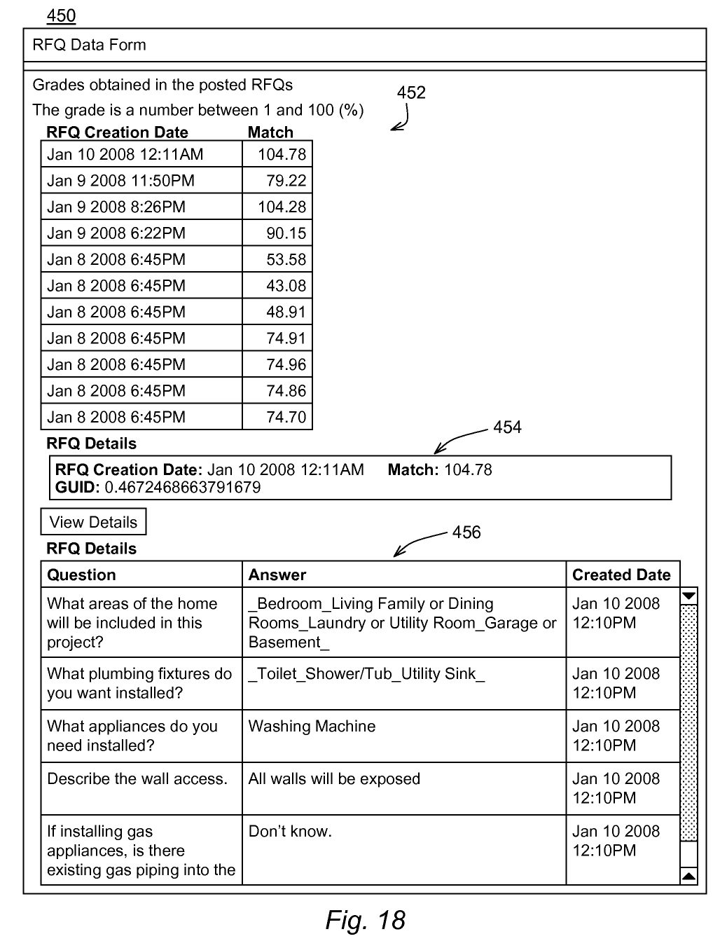

With reference now to FIG. 18, an exemplary RFQ data form 450 is shown. The RFQ data form 450 includes, e.g., a posted RFQ grade area 452, a first RFQ detail area 454, and a second RFQ detail area 456. At the previously described vendor matching step 16, once the RFQ form is completed, the user submits the form and the application matching engine can:
(a) Transform the request information into keyword metadata and categories and then retrieve the vendors with the highest relative index to the keyword metadata;
(b) Rank the request information into sets of criteria; e.g. zip code (location), project characteristics, pricing range, and scheduling;
(c) Perform a matching evaluation of vendors based on profile characteristics, lead budget, etc.;
(d) Calculate an aggregate score for the vendors based on the matching evaluation; and
(e) Select the top vendors based on matched ranking.

The top-selected vendors can be listed in the application with check boxes next to their business name and a link that takes the user to a vendor information page. This page can offer links that will provide details regarding the vendor, their customer service rating, their availability and their breadth of expertise.

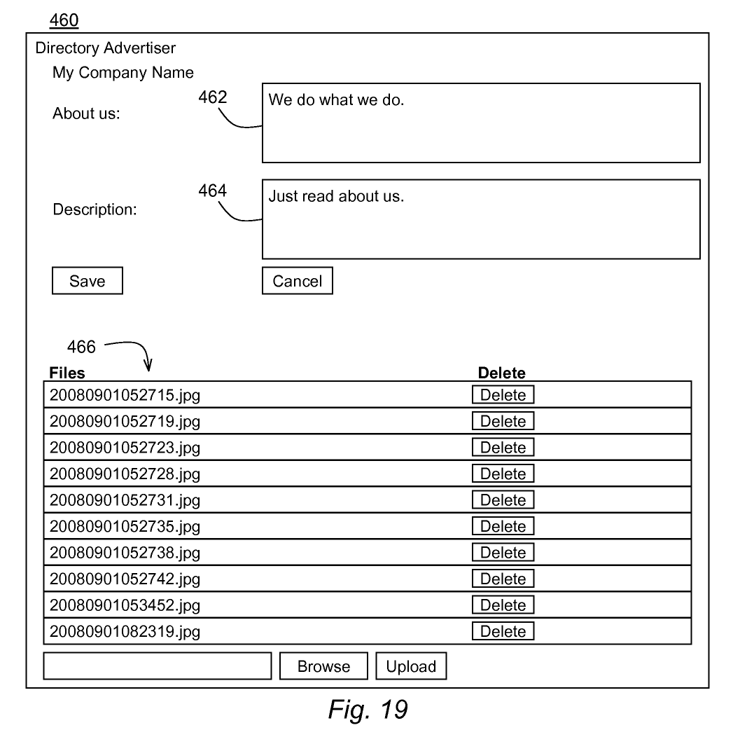

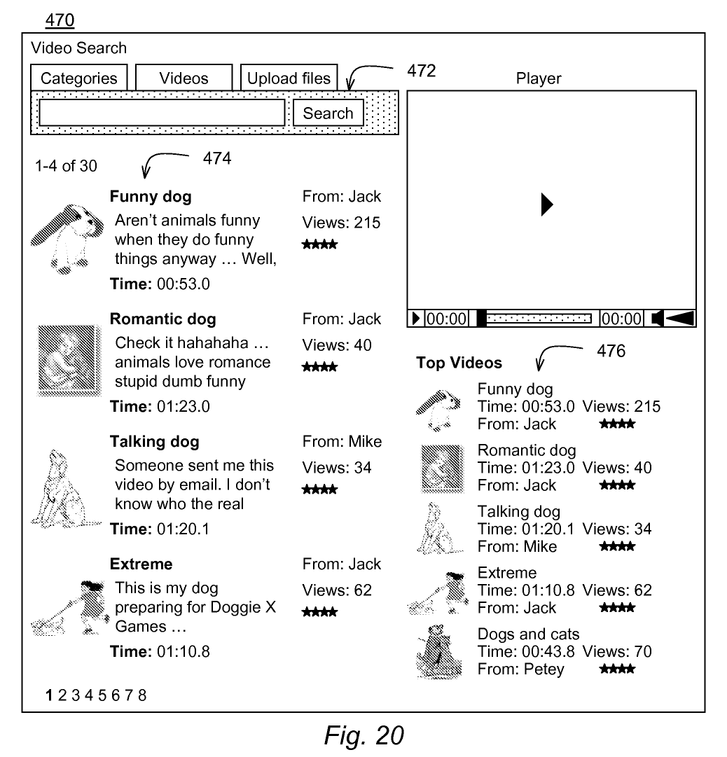

Vendors are provided the option of having their Directory Print, newspaper or magazine Advertisement come up with the search results (not a link). Programmed Links to the Print Directory are able to pull an image of the Print Advertisement. With reference now to FIG. 19, an exemplary Directory Print Advertisement configuration screen 460 is shown. The screen preferably includes an “About Us” information area 462 and a Description area 464 where the vendor provides appropriate descriptive information about the services they offer. Also shown is a file upload area 466 where the vendor is able to list files such as, e.g., image files for uploading to a database repository for the video commercials in the RPRR system for inclusion in the Directory Print Advertisement. Vendors are also provided the option of having a short video commercial appear with their search results in the form of a link for the user to select for viewing. With reference now to FIG. 20, an exemplary Video Search screen 470 is shown. The video search screen includes a video search input area 472 for entering keyword or title information for conducting searches. A video search result area 474 shows thumbnails for videos satisfying the search, and the thumbnails are preferably in the form of active links for viewing the full video. A Top Videos area 476 is included in preferred embodiments for showing the most popular videos.

The user, after optionally viewing any selected vendor advertising, is given the choice of eliminating any vendor or vendors to whom they do not wish to distribute their RFP. The user is also given the opportunity to add the name of a vendor that they would like to see added to the list provided they have the appropriate contact information. Should a user not wish to see a specific vendor appear again in future searches, the RPRR system includes the ability to capture that requirement at the moment the user clicks or does not click on a specific vendor. The user is preferably provided the ability to choose that a specific vendor does not come up on future searches. This decision, of course, does not affect other users.

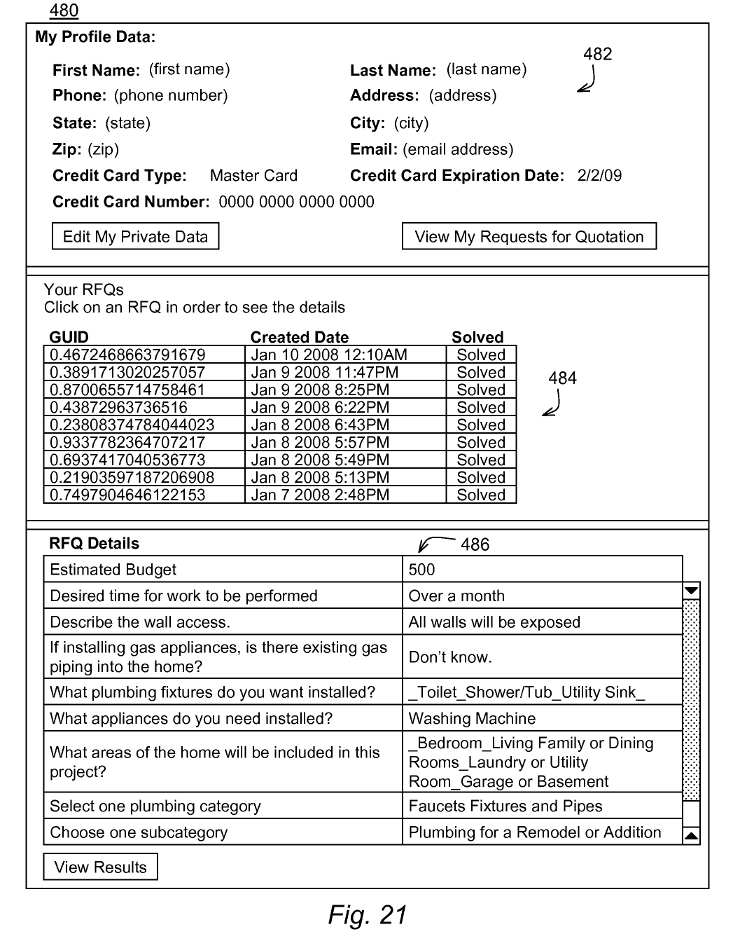

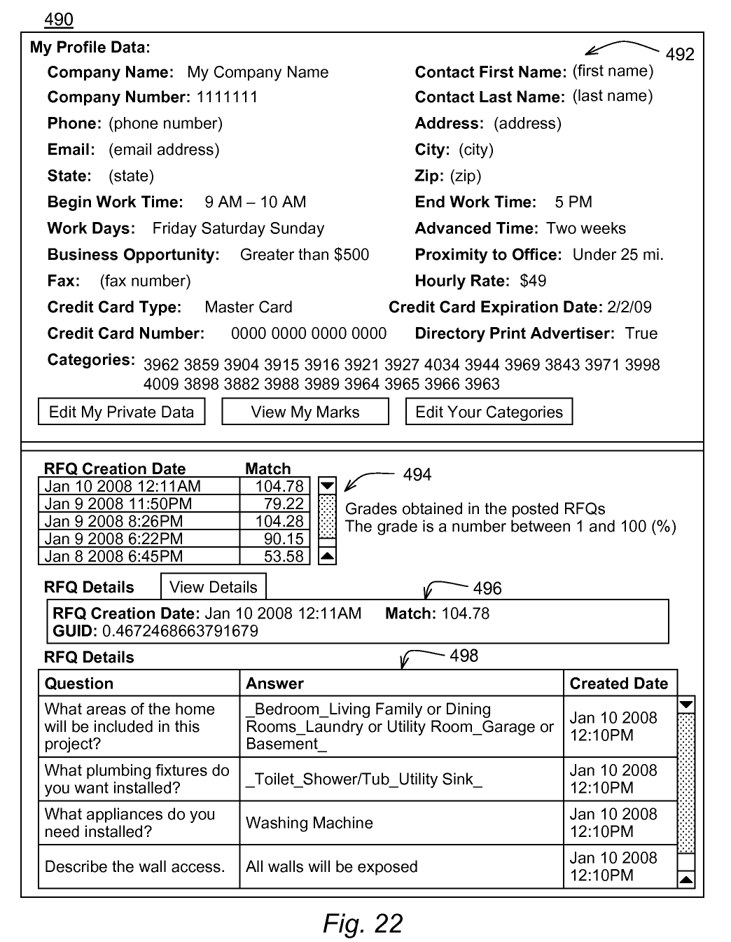

With reference now to FIG. 21, an alternate member profile screen 480 is shown. The alternate user profile screen includes, not only private member profile data 482, but also a list of recent (or all) RFQs 484. The user is provided the option of selecting one of the listed RFQs in order to display detailed RFQ information 486 for the selected RFQ. With reference now to FIG. 22, an alternate vendor profile screen 490 is shown. The alternate vendor profile screen includes, not only private vendor profile data 492, but also a list of grades received on posted RFQs 494. The vendor is also provided the option of selecting one of the listed posted RFQs in order to display detailed RFQ information in a first RFQ detail area 496 and a second RFQ detail area 498.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A computer-implemented reverse online auction method, the method comprising:
receiving a vendor registration from each of a plurality of vendors, wherein receiving a vendor registration comprises:
receiving vendor product and service information;
receiving vendor contact information; and
storing the received vendor product and service information and the received vendor contact information in a database;
receiving a client request lead from a client, the client request lead comprising a request for proposal (RFP) or a request for quote (RFQ), wherein receiving a client request lead comprises:
receiving proposed project information if the client request lead is an RFP;
receiving vendor product information if the client request lead is an RFQ; and
storing the received proposed project information and the received vendor product information in the database;
distributing selected client request lead information from the database to at least one of the plurality of vendors, the selected client request lead information providing information identifying the RFP or the RFQ, and the selected client request lead information excluding client contact information;
accepting an opportunity to bid for the distributed client request lead by at least one of the plurality of vendors receiving the distributed selected client request lead information;
submitting a bid for the distributed client request lead by at least one of the plurality of vendors accepting the opportunity to bid;
determining at least one winning bidder from the at least one of the plurality of vendors submitting a bid for the client request lead; and
providing client contact information to at least one winning bidder.

2. The method according to claim 1, further comprising:
receiving vendor content, the vendor content including advertising material for the associated vendor; and
creating and storing a vendor profile for each vendor based on the received product and service information of the associated vendor.

3. The method according to claim 2, further comprising:
automatically matching the client request lead information to the plurality of vendors based on the created vendor profiles to determine selected matching vendors, wherein distributing selected client request lead information comprises distributing the selected client request lead information only to the selected matching vendors.

4. The method according to claim 3, further comprising:
automatically generating an index rating for each of the plurality of vendors, by a learning algorithm, wherein the index rating is based on the vendor profile, the vendor products and services, and the vendor content.

5. The method according to claim 4, wherein automatically matching the client request lead information to the plurality of vendors further comprises:
performing a rules-based matching of the client request lead information to the plurality of vendors based on the created vendor profiles, characteristics of the vendors, the index rating, and characteristics of the client request lead to determine the selected matching vendors.

6. The method according to claim 2, further comprising:
automatically matching the client request lead information to the plurality of vendors based on the created vendor profiles to find candidate matching vendors;
providing to the client a candidate list including the candidate matching vendors; and
choosing, by the client, selected matching vendors from the candidate list, wherein distributing selected client request lead information comprises distributing the selected client request lead information only to the selected matching vendors.

7. The method according to claim 6, further comprising:
notifying the client if no candidate matching vendors are found.

8. The method according to claim 6, further comprising:
storing client feedback information provided by the selected vendors regarding the client;
storing vendor feedback information provided by the client regarding at least one of the selected vendors;
displaying the stored vendor feedback information to the client; and
displaying the stored client feedback information to the selected vendors.

9. The method according to claim 6, further comprising:
generating and storing a lead purchase record in a vendor fees database for the at least one of the plurality of vendors accepting the opportunity to bid, the lead purchase record including charge information related to the acceptance of the opportunity to bid.

10. The method according to claim 9, further comprising:
evaluating each of the submitted bids based on a bid profile, a search profile, bid history from previous submitted bids, and a bid ranking, the bid ranking based on a range of bids for each of the plurality of vendors;
sorting the evaluated bids; and
determining at least one high bidder based on the sorted bids.

11. The method according to claim 10, further comprising:
limiting the number of vendors accepting the opportunity to bid to a predetermined number of bidders; and
billing each of the vendors accepting the opportunity to bid.

12. The method according to claim 11, wherein billing each of the vendors comprises:
determining a billing amount equal to a lowest bid submitted by the at least one high bidder.

13. A computer-implemented reverse online auction method, the method comprising:
performing a dynamic rules-based configuration;
receiving a vendor registration from each of a plurality of vendors, and storing the vendor registration in a database;
creating and storing in the database, a vendor profile for each vendor based on answers to a plurality of question-and-answer sets provided by the vendor, and based on product and service information received from the associated vendor;
receiving a client request lead from a client;
automatically matching the client request lead information to the plurality of vendors to determine at least one selected vendor;
distributing selected client request lead information to only the at least one selected vendor, the selected client request lead information excluding client contact information;
accepting an opportunity to bid for the distributed client request lead by at least one of the selected vendors, the selected vendors accepting the opportunity to bid becoming candidate vendors;
submitting a bid for the distributed client request lead by at least one of the candidate vendors accepting the opportunity to bid;
determining at least one winning bidder from the at least one of vendors submitting a bid for the client request lead; and
providing client contact information to at least one winning bidder.

14. The method according to claim 13, wherein:
the performing a dynamic rules-based configuration comprises:
generating the plurality of question-and-answer sets, the question-and-answer sets including branching to other questions based on configured rules;
organizing the question-and-answer sets based on industry specific information from each vendor, the question-and-answer sets organized from a low level of detail to a high level of detail based on information provided by the vendor; and
configuring rules for defining a linking order of the question-and-answer sets; and
the receiving a vendor registration from each of a plurality of vendors comprises:
receiving the vendor product and service information;
receiving vendor contact information;
receiving vendor content, the vendor content including advertising material for the associated vendor; and
storing the received vendor product and service information, the received vendor contact information, and the received vendor content in the database.

15. The method according to claim 14, wherein automatically matching the client request lead information comprises:
transforming the client request lead information into keyword metadata and categories and selecting vendors with a highest relative index to the keyword metadata;
ranking the request information into sets of criteria;
performing a matching evaluation of vendors based on client lead profile characteristics;
calculating an aggregate score for the vendors based on the matching evaluation; and
selecting the top vendors as the selected matching vendors based on the aggregate score.

16. The method according to claim 15, further comprising:
accessing the keyword metadata by a learning algorithm which applies defined training scenarios during the ranking to organize the request information into categories.

17. The method according to claim 14, further comprising:
providing to the client a candidate list including the candidate vendors; and
choosing, by the client, selected matching vendors from the candidate list, wherein distributing selected client request lead information comprises distributing the selected client request lead information only to the selected matching vendors.

18. The method according to claim 17, further comprising:
adding, by the client, a vendor other than a candidate vendor to the candidate list.

19. The method according to claim 17, further comprising:
evaluating each of the submitted bids based on a bid profile, a search profile, bid history from previous submitted bids, and a bid ranking, the bid ranking based on a range of bids for each of the plurality of vendors;
sorting the evaluated bids;
determining at least one high bidder based on the sorted bids;
limiting the number of vendors accepting the opportunity to bid to a predetermined number of bidders; and
billing each of the vendors accepting the opportunity to bid.

20. A system for performing a reverse online auction, comprising:
a server system, comprising:
a computer system;
a network interface for communicating with at least one of a client system and a vendor system;
a user interface;
a storage system for storing at least one database utilized by the server system, the at least one database; and
a database server in communication with the server system for performing database retrieval and storage functions;
wherein the server system is configured to perform a reverse online auction comprising the steps of:
performing a dynamic rules-based configuration comprising:
generating and storing on the storage system, a plurality of question-and-answer sets, the question and answer sets including branching to other questions based on configured rules;
organizing the question-and-answer sets based on industry specific information from each vendor, the question-and-answer sets organized from a low level of detail to a high level of detail based on information provided by the vendor; and
configuring rules for defining a linking order of the question and answer sets;
receiving via the network interface a vendor registration from each of a plurality of vendors, wherein receiving a vendor registration comprises:
receiving vendor product and service information;
receiving vendor contact information; and
receiving vendor content, the vendor content including advertising material for the associated vendor;
creating and storing on the storage system a vendor profile for each vendor based on answers to the question and answer sets provided by the vendor, and based on the received product and service information of the associated vendor;
receiving via the network interface a client request lead from a client;
automatically matching the client request lead information to the plurality of vendors to determine at least one selected vendor;
distributing via the network interface selected client request lead information to only the at least one selected vendor, the selected client request lead information excluding client contact information;
accepting an opportunity to bid for the distributed client request lead by at least one of the selected vendors, the selected vendors accepting the opportunity to bid becoming candidate vendors;
receiving a bid for the distributed client request lead, the bid submitted by at least one of the candidate vendors accepting the opportunity to bid;
determining at least one winning bidder from the at least one of vendors submitting a bid for the client request lead; and
providing client contact information to the at least one winning bidder.
